(19) United States
(12) Patent Application Publication
(10) Pub. No.: US 2023/0046765 A1
(43) Pub. Date: Feb. 16, 2023

(54) ELECTRIC TRANSFORMER WITH A DEFINITE IMPEDANCE BY MEANS OF A SECOND MAGNETIC CIRCUIT

(71) Applicant: Exxelia, Paris (FR)

(72) Inventors: Victor William Quinn, Rush, NY (US); Benoit Bertrand Hugues Krafft, BRIN SUR SEILLE (FR)

(73) Assignee: Exxelia, Paris (FR)

(21) Appl. No.: 17/399,328

(22) Filed: Aug. 11, 2021

(51) Int. Cl. H01F 27/30; H01F 27/255; H01F 27/38; H01F 3/14

(52) U.S. Cl. CPC H01F 27/306; H01F 27/255; H01F 27/38; H01F 3/14

(57) ABSTRACT

An electric transformer comprising a primary coil, a secondary coil and a first magnetic circuit, the first magnetic circuit comprising at least a first limb and a second limb, the primary coil being wound around the first limb of the first magnetic circuit and the secondary coil being wound around the first limb or the second limb of the first magnetic circuit, wherein the electric transformer further comprises a second magnetic circuit acting as a component for setting a total impedance of the electric transformer at a predetermined value, the second magnetic circuit comprising at least a third limb, only one coil among the primary coil and the secondary coil being wound around the third limb of the second magnetic circuit, the second magnetic circuit being independent of the first magnetic circuit.

### FIELD

The present invention relates to an electric transformer.

An electric transformer comprises a primary coil and a secondary coil, coupled magnetically one with the other, preferably by using a magnetic circuit. The magnetic circuit, also called a magnetic core, forms a closed magnetic loop comprising two or more limbs connected by yokes. The primary coil is wound around one limb, while the secondary coil is wound around the same or another limb of the magnetic circuit.

### BACKGROUND

Electrically speaking, as illustrated by the equivalent circuit of FIG. 1, a real transformer 10 can be represented by an ideal transformer 11 and a leakage inductance LS in series with a losses resistance RS. The leakage inductance LS is conventionally represented in series with the primary coil of the transformer, but, as shown in FIG. 1, it can as well be represented in series with the secondary coil of the transformer (taking into account the turns ratio of the transformer). The leakage inductance LS and the losses resistance RS together form an equivalent leakage impedance that can significantly affect the operation of the transformer.

The ideal transformer 11 has a primary coil 12 made of n1 turns, and a secondary coil 12 made of n2 turns. A magnetic circuit 13 guides the magnetic field lines from the primary coil 12 to the secondary coil 14. When an electric tension V1 is applied between the terminals of the primary coil 12 of the ideal transformer 11, the electric tension generated between the terminals of the secondary coil 14 is given by: (n2/n1)×V1. At the same time, if an electric intensity I1 flows through the primary coil 12, the electric intensity I2 generated through the secondary coil 14 is given by: (n1/n2)×I1. Due to the equivalent leakage impedance (LS and RS), the electric tension V2 between the terminals of the real transformer 10 differs from (n2/n1)×V1.

The losses resistance RS represents the power lost in the form of heat, by Joule effect, in the conductors.

The leakage inductance LS represents leakage flux effects caused by magnetic field lines that are not mutually shared by both primary and secondary coils.

The value of the leakage inductance LS depends of several parameters, in particular the effective shape given to each turns of the primary and secondary coils. Since this shape may differ from one transformer to the other, even along a common production line, the leakage inductance LS presents a great variability. As a result, the leakage impedance tolerances of commercial transformers are wide. The tolerance is generally expressed as a percentage (the deviation from the average value divided by the average value). It can be of more than 50%.

Consequently, a particular real transformer has to be associated with additional inductive or capacitive components to increase or otherwise adjust the value of the total leakage inductance of the transformer, as required by the circuit in which this particular transformer is used. This adjustment is a burden for the circuit manufacturer. In addition, the additional components make the circuit bulky and may cause ongoing tuning operations in production since the values of the additional components are based on the leakage inductance value of the transformer prior to adjustment.

### SUMMARY OF THE INVENTION

This invention addresses these issues by providing an electric transformer with a controlled and definite leakage impedance.

According to a first aspect, the present invention provides an electric transformer comprising a primary coil, a secondary coil and a first magnetic circuit, the first magnetic circuit comprising at least a first limb and a second limb, the primary coil being wound around the first limb of the first magnetic circuit and the secondary coil being wound around the first limb or the second limb of the first magnetic circuit, wherein the electric transformer further comprises a second magnetic circuit acting as a component for setting a total impedance of the electric transformer at a predetermined value, the second magnetic circuit comprising at least a third limb, only one coil among the primary coil and the secondary coil being wound around the third limb of the second magnetic circuit, the second magnetic circuit being independent of the first magnetic circuit.

According to a second aspect, the present invention provides an electric transformer comprising a primary coil, a secondary coil and a first magnetic circuit, the first magnetic circuit comprising at least a first limb and a second limb, the primary coil being wound around the first limb of the first magnetic circuit and the secondary coil being wound around the first limb or the second limb of the first magnetic circuit, wherein a first coil among the primary coil and the secondary coil is made of at least one first winding, the first winding being made of a wire comprising a first section, a second section and a middle section between the first and the second sections, the first section forming a first spiral around an axis and the second section forming a second spiral around the axis, the first and second spirals being located in two separate planes perpendicular to the axis, an inner end of the first spiral, respectively the second spiral, located near the axis being near the middle section of the first winding and an outer end of the first spiral, respectively the second spiral, located away from the axis being near a free end of the first winding, the first spiral and the second spiral turning around the axis in opposite directions.

According to a third aspect, the present invention provides an electric transformer comprising a primary coil, a secondary coil and a first magnetic circuit, the first magnetic circuit comprising at least a first limb and a second limb, the primary coil being wound around the first limb of the first magnetic circuit and the secondary coil being wound around the first limb or the second limb of the first magnetic circuit, wherein the first magnetic circuit comprises three first parallel limbs, the three first parallel limbs being connected by two first yokes, the three first parallel limbs comprising a central first limb and two outer limbs, and wherein the primary coil and/or the secondary coil is made up of a plurality of windings, the plurality of winding comprising at least one central winding and two outer windings, the central winding being wound around the central first limb and the two outer windings being wound around the two outer limbs.

### BRIEF DESCRIPTION OF THE DRAWINGS

FIG. 1 is an electric representation of a circuit equivalent to a real transformer;

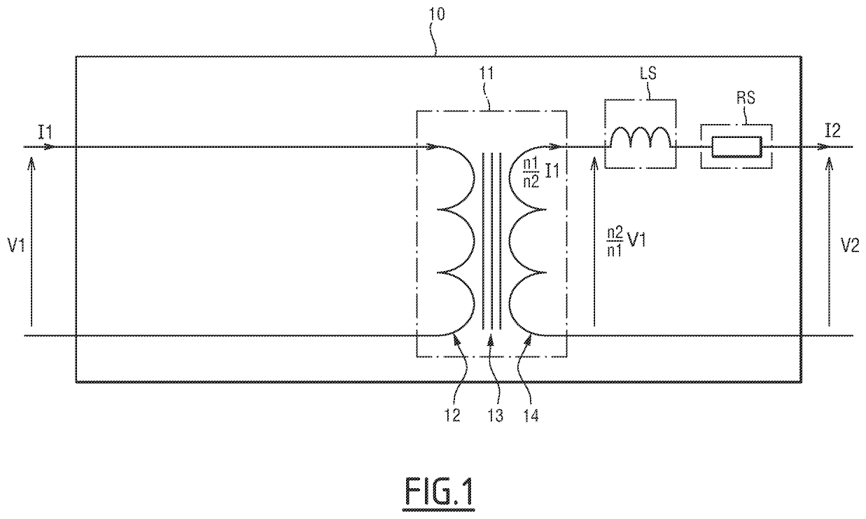

FIG. 2 is a perspective view of a preferred embodiment of an electric transformer according to the invention;

FIG. 3 is an exploded perspective view of the frame and the secondary coil of the transformer of FIG. 2;

FIG. 4 is a perspective view of one primary winding of the primary coil of the transformer of FIG. 2;

FIG. 5 is a perspective view of the assembly of primary and secondary windings on the frame of the transformer of FIG. 2;

FIG. 6 is a perspective view of parts of the transformer of FIG. 2 With the first and second magnetic circuit partially exploded; and

FIG. 7 is a perspective view of another embodiment of an electric transformer according to the invention.

### DETAILED DESCRIPTION

### Preferred Embodiment

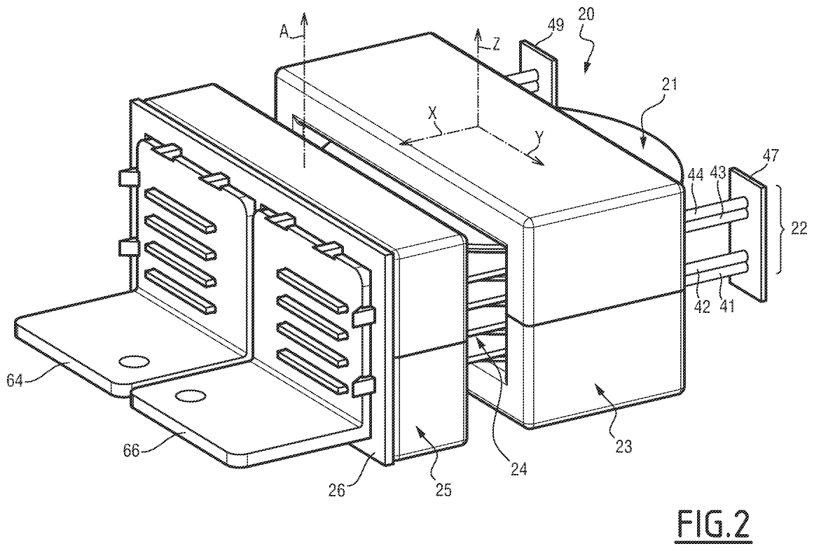

FIGS. 2 to 6 illustrate a first and preferred embodiment of an electric transformer 20 according to the invention.

Axis X, Y and Z define a system of reference attached to the transformer 20.

The transformer 20 comprises a frame 21, a primary coil 22, a secondary coil 24, a first magnetic circuit 23 and a second magnetic circuit 25.

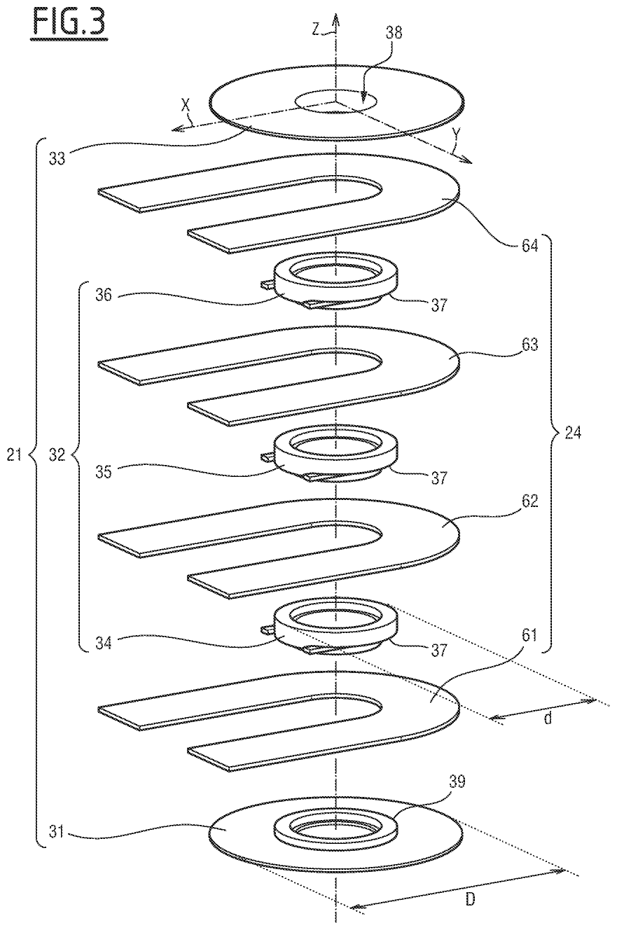

As represented in exploded view in FIG. 3, the frame 21 comprises a cylindrical part 32 and two end flanges, respectively 31 and 33.

The frame 21 is hollow to define a through hole 38 along axis Z to accommodate a central limb of the first magnetic circuit 23.

Axis Z is oriented arbitrarily. The adjectives of “upper” or “lower” are thus defined relatively, along axis Z.

The cylindrical part 32 of the frame 21 is preferably modular. For example, in the first embodiment, the cylindrical part 32 is made of three identical and annular modules, 34, 35 and 36, stacked one above the other along the axis Z. Each module is shaped so as to be fitted with its neighbor or an end flange. One face, for example the lower face of each module, is provided with a groove 37 in order to accommodate one secondary winding as it will be described below.

The end flanges, 31, 33, are respectively mounted at the ends of the cylindrical part 32. The diameter D of one end flange is greater than the diameter d of the cylindrical part 32. The face of an end flange that is oriented toward the cylindrical part 32 is provided with a rim 39, whose height is adapted to space one secondary winding away from the end flange.

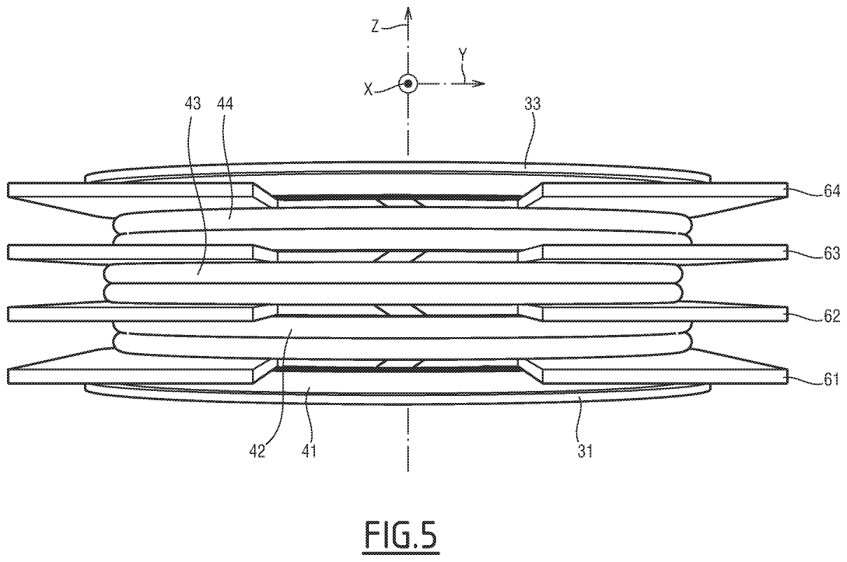

The primary coil 22 is made of several primary windings. Each primary winding is wound around the cylindrical part 32 of the frame 21 as can be seen in FIG. 5.

In the first embodiment, the primary coil 22 is for example made of four windings, respectively 41, 42, 43 and 44.

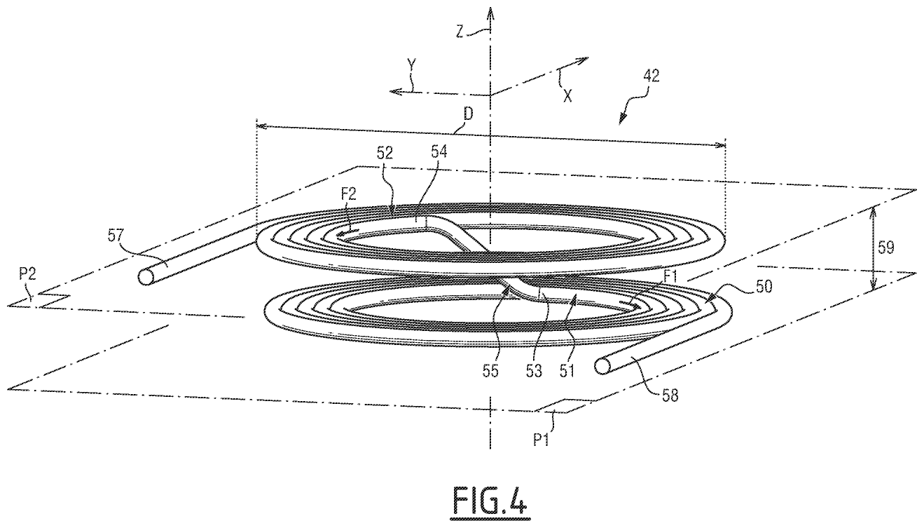

Each the primary winding, as exemplified in FIG. 4 by primary winding 42, is advantageously made of a copper wire 50. The primary winding 42 is preferably integral, i.e. it is made of a single wire with no internal connections.

The wire is made of a conductive material insulated with a dielectric coating or one or several insulating layer(s) wrapped around the conductive material to provide insulation on the surface of the wire along its length.

The conductive material of the wire may be composed of copper, aluminum, an alloy of copper or aluminum, or another conductive metal.

This conductive material may be composed of one solid conductor or multiple filaments, preferably twisted together.

The wire 50 comprises a middle section 55 connecting a first half 51 of the wire 50 and a second half 52 of the wire 50.

The first section 51 forms a first flat spiral around axis Z and the second section 52 forms a second flat spiral around axis Z. The first and second flat spirals are located in two parallel and separate planes, which are perpendicular to the axis Z, a lower plane P1 and an upper plane P2, respectively for primary winding 42.

An inner end 53 of the first section 51 is linked to the inner end 54 of the second section 52 by the middle section 55 of the wire 50. This middle section 55 thus crosses the gap 59 between the upper and lower planes, P1 and P2, in the vicinity of the cylindrical part of the frame 21 when the primary winding is in position.

The outer ends, 58, 57, of the first section 51 and the second section 52 respectively, constitutes the terminals of the primary winding 42. The outer ends 58 of the first section 51 lies in the lower plane P1 and the outer end 57 of the second section 52 lies in the upper plane P2.

Due to this configuration, the primary winding has no lead cross over. This means that the wire at the inner end of the spiral does not have to be routed outwardly above or below the spiral. Thus, the equivalent of the thickness of the wire is saved. Consequently, the primary winding is more compact, at least along axis Z.

In order the magnetic fluxes generated by the first section 51 and the second section 52 add along the axis Z in the gap 59 separated them, the first spiral turns for example clockwise around the axis Z (arrow F1 in FIG. 4), while the second spiral turns counterclockwise around the axis Z (arrow F2 in FIG. 4), when the primary winding 42 is seen from above.

The method of manufacturing such a winding starts from the middle section 55 of the wire which is positioned near the cylindrical part 32 of the frame 21. The first section 51 of the wire 50 is then wound on itself in the lower plane, for example by rotating the arrangement around the axis Z counterclockwise. Then the second section 52 of the wire is wound on itself in the upper plane by rotating the arrangement around the axis Z clockwise.

The first and second spirals have preferably the same numbers of turns.

In the embodiment of FIGS. 2 to 6, one primary winding is connected in parallel with the other primary windings. The outer ends of the primary windings located on the same side of the transformer are connected together by means of flat plates, 47, 49 respectively, constituting the input terminals of the transformer 20. The connection is done for example by a mere soldering. Alternatively, the primary of the transformer may include series connections or a combination of series and parallel connections.

Since the gap 59 between upper and lower spirals of the same primary winding may be arbitrarily adjusted, the electric energy generated from the electric potential difference between the two spirals can be mitigated. This reduction of electric energy (or equivalent capacitive effect) can therefore be provided in a preferred profile along axis Z with only a suitable extension of middle section 55.

The equivalent capacitive effect is then mostly caused by the potential difference between each turn of one spiral. A conventional winding according to the prior art wound in the same envelope would suffer increased potential difference between turns accumulated radially and may compel increased insulation between turns to mitigate equivalent capacitive effect. The conventional winding also requires the inner end of the winding to cross over the winding to provide suitable termination. This cross over often compels additional insulation. Therefore, the conventional winding often requires introduction of accumulated insulation layers which decrease dimensional consistency and therefore causes inconsistency in the leakage inductance LS.

Therefore, the invention, by winding two spirals, exhibits a reduced voltage gradient between the layers of one winding and therefore reduces equivalent capacitive energy and increases the self-resonant frequency of the coil while facilitating dimensional consistency. This dimensional consistency decreases the tolerance on the leakage inductance LS.

In this first embodiment, the secondary coil 24 is made of four secondary windings, 61, 62, 63, 64, connected in parallel by “L” shaped plates 64 and 66, each of them constituting one terminal of the secondary coil 24.

Each secondary winding is wound around the cylindrical part 32 of the frame 21.

When using a middle point start wound wire as primary winding as in the present embodiment, the secondary winding is advantageously made of a “U” shaped flat wire. In this regard, as shown in FIG. 2, the secondary coil 24 comprises secondary windings 61, 62, 63, 64, each made of a “U” shaped flat wire.

As shown in FIG. 3, each “U” shaped flat wire is inserted in one corresponding groove 37 provided on the cylindrical part 32 of the frame 21. The dimensions of groove 37 match those of one “U” shaped flat wire in order to maintain it in position.

The two free ends of the “U” shaped flat wire protrude beyond the end flanges 31, 33 of the frame 21.

The aperture between the two arms of one “U” shaped flat wire provides a pass through for positioning the middle portion 55 of the wire 50 used for winding the primary winding around the cylindrical part 32 of the frame 21 so that its first spiral is located directly underneath the “U” shaped flat wire and its second spiral is located directed above the “U” shaped flat wire. The “U” shaped flat wire is thus positioned in the gap 59 between the spirals of the associated primary winding. Thus, as illustrated in FIG. 5, the secondary winding 61 is between the lower spiral and the upper spiral of primary winding 41, the secondary winding 62 is between the lower spiral and the upper spiral of primary winding 42, the secondary winding 63 is between the lower spiral and the upper spiral of primary winding 43, and the secondary winding 64 is between the lower spiral and the upper spiral of primary winding 44.

It is to be noted that the use of a flat wire as secondary winding provides a sufficient mechanical strength to separate adjacent segments of one primary winding consistently. In addition, the flat wire may provide the function of improved heat transfer to an heat sink (not shown on the drawings) external to the transformer. Insulation coatings on the windings replace the need for insulation provided by bobbin flanges in conventional assembly Therefore, according to the invention, dedicated bobbin flanges to consistently position the primary winding are eliminated while adding a preferred benefit of improved heat transfer, leading to a more compact assembly.

Referring back to FIG. 2, each “L” shaped plate, 64, 66, is a flat metal conductor provided with slots into which the free end of one arm of each “U” shaped flat wires are inserted. The dimensions of each slot matches those of the free ends of the “U” shaped flat wires to be sure that these parts are in close contact, assuring an electric continuity with connection by mere soldering or equivalent.

The “U” shaped flat wires are connected in parallel in the particular embodiment shown in the figures. Alternatively, the secondary of the transformer may include series connections or a combination of series and parallel connections.

In the first embodiment, with the four primary windings (each of n1 turns) in parallel and the four secondary windings (each of n2=1 turn) in parallel, the relation is: I2=n1×I1, where I1 is the current between input terminals of the transformer and I2 is the current between output terminals of the transformer, I2 being the sum of paralleled secondary currents and I1 being the sum of paralleled primary currents.

The first magnetic circuit comprises a core with multiple limbs.

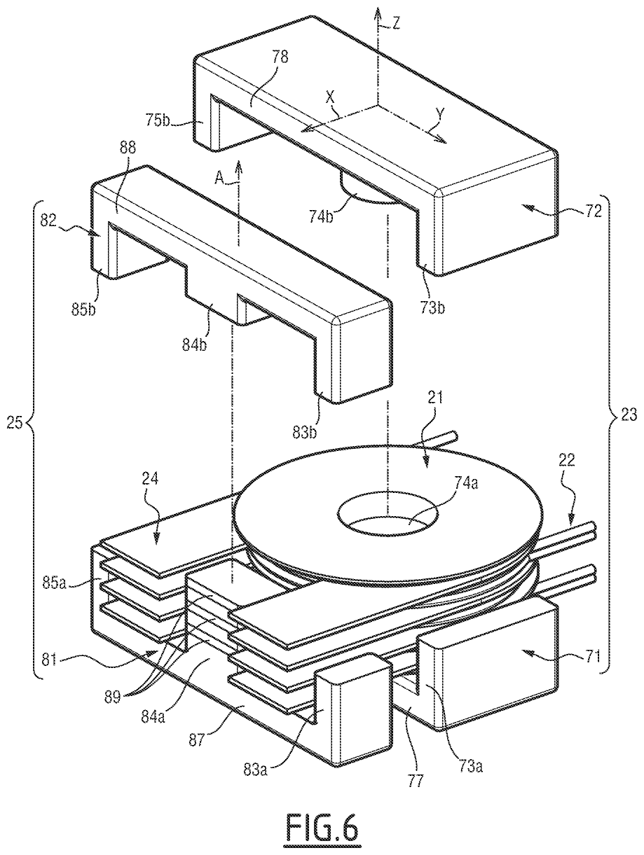

The core is for example made of a ferrite material. Alternatively it is made of lamination, wound ribbon, or agglomerated magnetic powder More particularly, as shown with more clarity in FIG. 6, the first magnetic circuit 23 results of the assembly of two “E” shaped pieces, respectively 71 and 72. When assembled, the first magnetic circuit 23 presents three parallel limbs, 73a and 73b, 74a and 74b and 75a (hidden in FIG. 6) and 75b, that are connected by two yokes 77 and 78.

The central limb is cylindrical. Its diameter is adapted to the inner diameter of through hole 38 provided in the frame 21 in order to be accommodated into said through hole 38. In position, the central limb is aligned with axis Z. The first magnetic circuit lies in an axial plane defined by axis Y and Z. The yokes are disposed respectively below and above the frame 21. Both the primary coil 22 and the secondary coil 24 are wound around the central limb.

The yokes and the external limbs have an aspect ratio to maximize the surface embedding the frame and the primary and secondary coils.

In addition to the reduction of insulation and lead between windings, the first magnetic circuit reduces the intensity of the radial leakage magnetic field, thus mitigating eddy current losses within the windings and within other conductors located in the vicinity of the windings. This reduction of eddy current losses improves power conversion efficiency.

According to the invention, a second magnetic circuit is used to provide additional magnetic flux paths using a core with multiple limbs. The second magnetic circuit is independent of the first magnetic circuit, i.e. they have no limb nor yoke in common.

The effective magnetic coupling between two or more windings sharing the first magnetic circuit may therefore be adjusted by distributing selected portions of these windings on selected limbs of the second magnetic circuit. Further adjustment of the effective magnetic coupling can be made by adjusting the design of the limbs of the magnetic circuits.

In FIG. 2 for example, the secondary magnetic circuit 25 is a core made of a ferrite material.

An insulation plate 26 is provided between the secondary magnetic circuit 25 and the two “L” shaped plates 64 and 66 constituting the output terminals of the transformer 20.

This second magnetic circuit is formed from the assembly of two “E” shaped pieces. respectively 81 and 82. When assembled, the second magnetic circuit 25 presents three parallel limbs, 83a and 83b, 84a and 84b, 85a and 85b, that are connected by two yokes, 87 and 88 respectively.

In position, the secondary magnetic circuit 25 lies in a plane parallel to the axial plane of the first magnetic circuit 23. The central limb 84a and 84b extends along an axis A parallel to the axis Z. Plane P5 is at a distance of axial plane P4 so that the central limb does not interfere with the frame 21. The central limb extends between the arms of the “U” shaped flat wires making up the secondary coil 24.

In the embodiment shown, only the secondary coil 24 is wound around the central limb 84a and 84b of the second magnetic circuit 25. The secondary magnetic circuit 25 is thus used to adjust the value of the effective leakage inductance LS of the transformer 20. The central limb may thus comprise one or several air-gap(s) 89 in order to precisely adjust the total impedance of the transformer.

In the first embodiment, the central limb 84a and 84b has a larger cross section than the two outer limbs 83a and 83b, 85a and 85b providing parallel flux return paths. Since the magnetic flux path from the central limb is split between the two outer limbs, it is advantageous that the central limb provides a cross section that is comparable to the sum of the cross sections for the outer limbs to promote uniform magnetic flux density and thereby efficient utilization of the available volume.

Since only one coil among the primary and secondary coils is wound around the second magnetic circuit, this latter acts as an impedance adapting component in order to adjust the final value of the total impedance of the transformer to a predefined value.

If possible, the manufacturing process may involve a final step of measuring the leakage impedance of the transformer that has just been produced and to adapt the shape and/or the numbers of air gaps 89 of the second magnetic circuit in order to provide the transformer with the desired total impedance.

In practice, the design of the transformer is based on the preselection of a secondary magnetic circuit incorporating air gaps of such significant size such that air gap adjustment in production will not be required even to provide a preferred definite leakage inductance LS. Multiple air gaps may be preferred rather than a single large gap to reduce detrimental fringing of magnetic field from the air gap into adjacent conductors. Such magnetic field fringing can cause significant eddy current losses that reduce transformer efficiency excessively. As further eddy current loss mitigation, the design configuration may preferably fix the air gaps at preferred heights along axis Z so that residual fringing magnetic field from each air gap is not adjacent to a secondary conductor 24.

In any case, the secondary magnetic circuit allows the average value of the leakage inductance and the deviation from this average value to be controlled.

### Second Embodiment

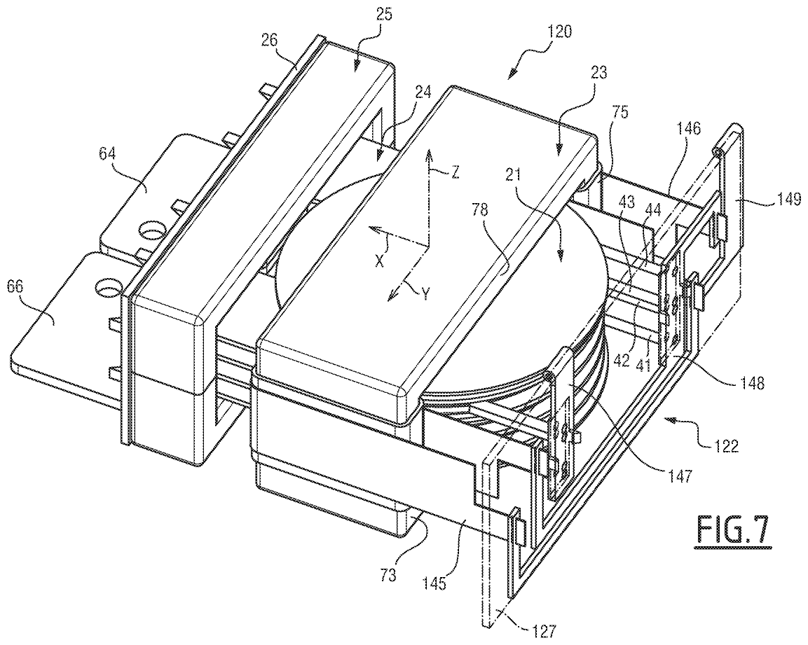

FIG. 7 shows a second embodiment of a transformer according to the invention.

A component of the second embodiment identical to a corresponding component of the first embodiment is identified with a reference numeral equal to the reference numeral used in the FIGS. 2 to 6 to identify this corresponding component of the first embodiment.

The transformer 120 is essentially identical to the transformer 20, except that the primary coil 122 is here modified.

More specifically, the primary coil 122 comprises a set of central primary windings in series with a set of outer primary windings.

The set of outer primary windings is made of a right primary winding 146 and a left primary winding 145 connected in parallel between a right plate 149 and a central plate 148. Each right and left primary windings are made of a flat wire making only one turn around an outer limb of the first magnetic circuit 23, respectively the right limb 75 for the right primary winding 146 and the left limb 73 for the left primary winding 145.

As in the first embodiment, the set of inner primary windings is made of four primary windings, 41, 42, 43 and 44. Each primary windings is made of a double-spiraled wire. The primary windings are stacked along axis Z. They are connected in parallel between the central plate 148 and a left plate 147.

The right and left plates 149 and 147 forms the input terminals of transformer 120.

The connection circuit of the first windings is mounted on an insulation plate 127.

The person skilled in the art will understand that, whereas in the first embodiment the relation between the input current I1 and the output current I2 is: I2=n1×I1, in the second embodiment, this relation becomes: I2=(n1+½)×I1.

The conversion ratio of the transformer can thus be adjusted with precision. This is particularly useful when n1 is small.

In other embodiments the left and right primary windings 145 and 146 respectively may be constructed from wires composed of one solid conductor or multiple filaments. Further, primary windings 145 and 146 respectively may further consist of a preferred number of turns to provide a preferred fraction of conversion. Such preferred fraction of conversion can be provided to a primary or secondary circuit with the effective magnetic coupling to another selected winding adjusted from the selected distribution of portions of these windings on related core limbs.

### OTHER EMBODIMENTS

In this preferred embodiment, the primary coil is wound around one limb of the first magnetic circuit, while the secondary coil is wound around the same one limb of the first magnetic circuit. Furthermore, the central void delimited by the secondary coil extends beyond the external perimeter of the first coil, so that this central void is able to accommodate one limb of the second magnetic circuit. Thus the secondary coil is wound around one limb of both the first and second magnetic circuits, while the first coil is wound around one limb of the first magnetic circuit only.

In an alternative embodiment, the primary coil is wound around several limbs of the first magnetic circuit and/or the secondary coil is wound around several limbs of the first magnetic circuit and/or the secondary coil is wound around several limbs of the second magnetic circuit.

In another alternative embodiment, the primary coil is wound around one or several limbs of the first magnetic circuit and one or several limbs of the second magnetic circuits, while the secondary coil is wound around one or several limbs of the first magnetic circuit only.

While the preferred embodiment applies to single phase transformer, the person skilled in the art will understand that its teaching can be directly applied to other types of transformer, in particular for three phase transformers. For the three phase transformer (and more generally to a multiple phase transformer with an arbitrary number of orthogonal phases) the number of core flux return limbs for the magnetic circuits can be reduced thereby affording volume reduction.

The principles of the invention can be applied to transformers of any size, for example transformers for which the windings are printed on circuit boards.

Applications and Benefits

The electric transformer according to the invention exhibits a tolerance on the value of total impedance that is lower than 10%.

The electric transformer according to the invention can benefit power electronic applications that usually require using additional inductive and/or capacitive components in primary or secondary circuits. In particular, the electric transformer according to the invention is well suited for Dual Active Bridge applications since a preferred value of the total impedance is beneficial to the transformer transfer function for these applications to reduce switching loss and facilitate bidirectional power flow.

The transformer herein provides this preferred value of the total impedance without additional components while mitigating eddy current losses since the leakage magnetic field associated with the leakage impedance LS is well controlled within the second magnetic circuit with reduction of leakage magnetic field intensity at conductor surfaces.

What is claimed is:

1. An electric transformer comprising:
a primary coil, a secondary coil and a first magnetic circuit, the first magnetic circuit comprising at least a first limb and a second limb, the primary coil being wound around the first limb of the first magnetic circuit and the secondary coil being wound around the first limb or the second limb of the first magnetic circuit,
wherein the electric transformer further comprises a second magnetic circuit acting as a component for setting a total impedance of the electric transformer at a predetermined value, the second magnetic circuit comprising at least a third limb, only one coil among the primary coil and the secondary coil being wound around the third limb of the second magnetic circuit, the second magnetic circuit being independent of the first magnetic circuit.

2. The electric transformer according to claim 1, wherein the second magnetic circuit is designed to set the total impedance to the predetermined value taking into account a value of a leakage impedance of an assembly made up of the primary coil, the secondary coil and the first magnetic circuit.

3. The electric transformer according to claim 1, wherein the second magnetic circuit comprises at least one air gap and/or is made of a magnetic material having an appropriate permeability.

4. The electric transformer according to claim 1, wherein the second magnetic circuit is made of two “E” shaped pieces providing, when assembled, the second magnetic circuit with three parallel second limbs, the three parallel second limbs being connected by two second yokes.

5. The electric transformer according to claim 4, wherein the three parallel limbs comprise a central limb and two outer limbs, a cross section of the central limb being greater than a total cross section of the two outer limbs.

6. The electric transformer according to claim 1, wherein the second magnetic circuit is made of a magnetic material in the form of ferrite, lamination, wound ribbon, or agglomerated magnetic powder.

7. The electric transformer according to claim 1, wherein the primary coil and/or the secondary coils is made up of at least one winding that is made of a wire, a first half of the wire forming a first flat spiral around an axis and a second half of the wire forming a second flat spiral around the axis, the first and second flat spirals being located in two separate planes perpendicular to the axis, the first spiral turning clockwise around the axis and the second spiral turning counterclockwise around the axis.

8. The electric transformer according to claim 1, wherein the primary coil and/or the secondary coil is made up of at least one winding that is made of a flat wire.

9. The electric transformer according to claim 1, wherein the primary coil and/or the secondary coil is made up of a plurality of windings, a first winding of the plurality of windings being connected in parallel or in series with a second winding of the plurality of windings.

10. The electric transformer according to claim 1, wherein the first magnetic circuit is made of two “E” shaped pieces providing, when assembled, the first magnetic circuit with three first parallel limbs, the three first parallel limbs being connected by two first yokes, the three first parallel limbs comprising a central first limb and two outer limbs, and wherein the primary coil and/or the secondary coil is made up of a plurality of windings, the plurality of winding comprising at least one central winding and two outer windings, the central winding being wound around the central first limb and the two outer windings being wound around the two outer limbs.
